(19) United States
(12) Patent Application Publication
(10) Pub. No.: US 2014/0297111 A1
(43) Pub. Date: Oct. 2, 2014

(54) VEHICLE CONTROL SYSTEM

(71) Applicant: HONDA MOTOR CO., LTD., Tokyo (JP)

(72) Inventor: Akio Takahashi, Shioya-gun (JP)

(73) Assignee: HONDA MOTOR CO., LTD., Tokyo (JP)

(21) Appl. No.: 14/228,082

(22) Filed: Mar. 27, 2014

(30) Foreign Application Priority Data
Apr. 2, 2013 (JP) 2013-077067

(51) Int. Cl. B60R 25/00

(52) U.S. Cl. CPC B60R 25/00
USPC 701/36

(57) ABSTRACT

A vehicle control system includes an alcohol detector which detects an alcohol intake level of a driver in a vehicle, and a controller which controls the alcohol detector so that a detection of the alcohol intake level is started during a run of the vehicle just after the vehicle starts up and initially moves. The controller determines whether the driver is a drunk person based on a detection result obtained from the alcohol detector, and the controller stops the vehicle when the controller determines that the driver is the drunk person.

### CROSS-REFERENCE TO RELATED APPLICATION

Priority is claimed on Japanese Patent Application No. 2013-077067, filed on Apr. 2, 2013, the content of which is incorporated herein by reference.

### BACKGROUND

1. Field of the Invention

The present invention relates to a vehicle control system.

2. Description of Related Art

In the related art, in order to prevent a drunk person from driving a vehicle, there is known a system that allows an engine start-up when the system determines that a driver of the vehicle is not a drunk person based on an alcohol test result obtained from an alcohol tester provided in the vehicle. However, after a non-drunk person boards the vehicle and the engine starts up, if the non-drunk person switches to a drunk person, the drunk person boards the vehicle as a driver.

As described above, in the related art, there is a problem that the drunk person pretends to be the non-drunk person and can drive the vehicle.

There is known a drunk driving prevention device having the following functions to solve the problem described above (for an example, refer to Japanese Unexamined Patent Application, First Publication No. 2010-6142).

The drunk driving prevention device operates an alcohol tester when the drunk driving prevention device detects a brake pedal depression which is one of a series of engine start-up operations. Then, the drunk driving prevention device allows an engine start-up only when the drunk driving prevention device determines that a driver is not a drunk person based on an alcohol test result obtained from the alcohol tester.

### SUMMARY

Incidentally, according to the drunk driving prevention device in the related art, there is a problem in that after the drunk driving test is completed and an engine starts up, the driver can be switched to a different person depending on a driving state of the vehicle and thus, the drunk driving prevention device cannot prevent a drunk person from pretending to be a non-drunk person and driving the vehicle.

Aspects according to the present invention is made in consideration of the aforementioned problem, and an object of the present invention is to provide a vehicle control system that accurately prevents a drunk person from pretending to be a non-drunk person and driving a vehicle.

An aspect according to the present invention includes the following measures for achieving the object related to solving the problem.

(1) A vehicle control system according to an aspect of the present invention includes: an alcohol detector which detects an alcohol intake level of a driver in a vehicle; and a controller which controls the alcohol detector so that a detection of the alcohol intake level is started during a run of the vehicle just after the vehicle starts up and initially moves. The controller determines whether the driver is a drunk person based on a detection result obtained from the alcohol detector, and the controller stops the vehicle when the controller determines that the driver is the drunk person.

(2) In the aspect of (1), in a case where the controller determines that the driver is not the drunk person, the controller may control the alcohol detector so that a new detection of the alcohol intake level is not started until at least one of a first condition in which a shift position of the vehicle is shifted to a position other than a drive position and a second condition in which an operation of a parking brake of the vehicle is performed, is established. When at least one of the first condition and the second condition is established, the controller may control the alcohol detector so that the new detection of the alcohol intake level is started, and determine whether the driver is the drunk person based on a new detection result obtained from the alcohol detector.

(3) In the aspect of (1), the controller may regulate a speed of the vehicle to a predetermined speed or less until a determination result indicating whether the driver is a drunk person is obtained.

(4) In the aspect of (1), the alcohol detector may include a breathalyzer type alcohol sensor provided farther outside than a steering wheel of the vehicle in a width direction of the vehicle.

(5) The aspect of (1) may further include a human body communicator which carries out a human body communication using the driver as a communication medium. The alcohol detector may include a touch type alcohol sensor provided on a steering wheel of the vehicle. The human body communicator may carry out the human body communication between the steering wheel, and a driver seat or an acceleration pedal of the vehicle. The controller may determine whether a person holding the steering wheel is the same as a person who sits in the driver seat or operates the acceleration pedal, based on a state of the human body communication carried out by the human body communicator.

According to the aspect of (1), it is possible to accurately prevent a drunk person from pretending to be a non-drunk person and driving a vehicle.

In addition, in the aspect of (2), a new detection of the alcohol intake level is not started until at least one of the first condition and the second condition is established. In other word, a new detection of the alcohol intake level is not started until the driver can be switched to a different person (that is, until a drunk person can pretend to be a non-drunk person). Therefore, according to the aspect of (2), it is possible to accurately prevent a drunk person from pretending to be a non-drunk person and driving a vehicle, and since the frequency of the alcohol detection (that is, the detection of the alcohol intake level) can be minimized, it is possible to reduce botheration of the alcohol detection when a non-drunk person drives a vehicle.

In addition, according to the aspect of (3), since a speed of the vehicle is regulated to a predetermined speed or less until a determination result indicating whether the driver is a drunk person is obtained, it is possible to ensure a desired level of safe driving even if the driver is a drunk person.

Furthermore, according to the aspect of (4) or (5), it is possible to further accurately prevent a drunk person from pretending to be a non-drunk person and driving a vehicle.

### BRIEF DESCRIPTION OF THE DRAWINGS

FIG. 1 is a configuration view of a vehicle control system according to an embodiment of the present invention.

FIG. 2 is a view illustrating the disposition of a breathalyzer type alcohol sensor included in an alcohol detector of the vehicle control system according to the embodiment of the present invention.

FIG. 3 is a flow chart illustrating an operation of the vehicle control system according to the embodiment of the present invention.

FIG. 4 is a view illustrating dispositions of a breathalyzer type alcohol sensor and touch type alcohol sensors which are included in an alcohol detector of a vehicle control system according to a modification example of the embodiment of the present invention.

FIG. 5 is a configuration view of the vehicle control system according to the modification example of the embodiment of the present invention.

### DESCRIPTION OF THE EMBODIMENT

Hereinafter, a vehicle control system according to an embodiment of the present invention will be described with reference to the accompanying drawings.

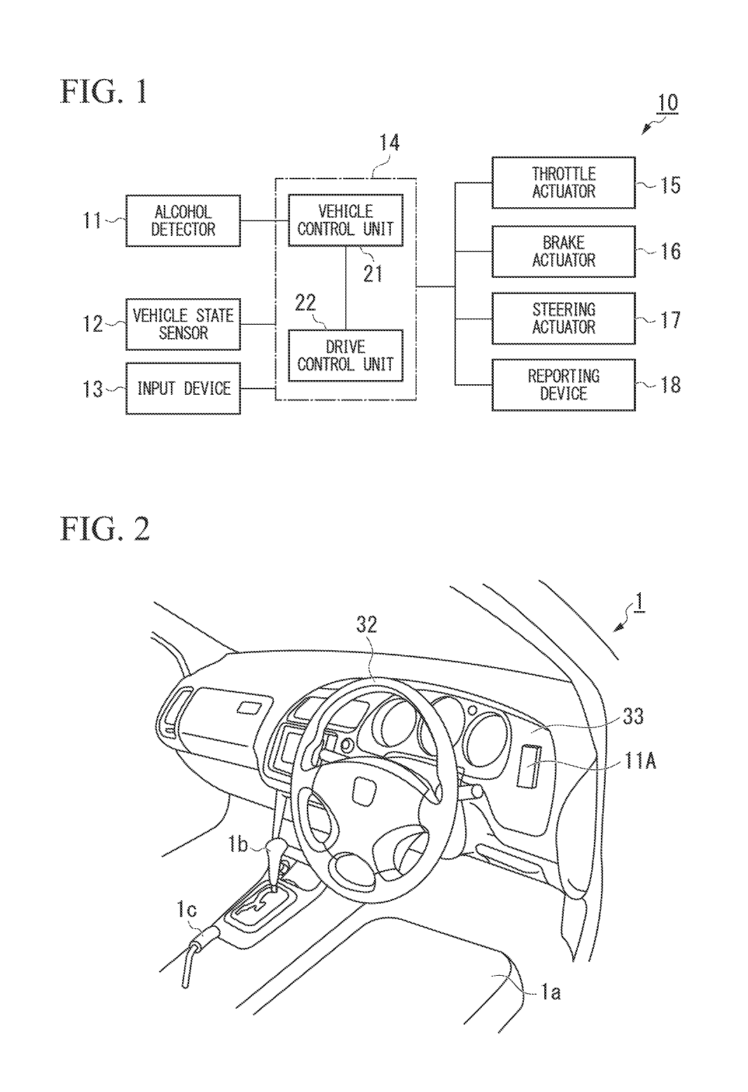

As illustrated in FIG. 1, a vehicle control system 10 according to the embodiment includes an alcohol detector 11, a vehicle state sensor 12, an input device 13, a controller 14, a throttle actuator 15, a brake actuator 16, a steering actuator 17, and a reporting device 18.

As illustrated in FIG. 2, for example, the alcohol detector 11 is disposed in the vicinity of a driver seat 1a of a vehicle 1. For example, the alcohol detector 11 includes a breathalyzer type alcohol sensor 11A that is disposed on an instrument panel 33 farther outside than a steering wheel 32 in a width direction of the vehicle 1. The breathalyzer type alcohol sensor 11A detects an alcohol density in an exhalation of a driver of the vehicle 1 as an alcohol intake level of the driver, and outputs a signal indicating a detection result of the alcohol density to the controller 14. In addition, the start timing of the detection of the alcohol density (that is, the alcohol intake level) in the alcohol sensor 11A is controlled by the controller 14.

The vehicle state sensor 12 detects various vehicle information of the vehicle 1, and outputs signals indicating the detected vehicle information to the controller 14.

The vehicle state sensor 12 includes a wheel speed sensor that detects the rotational speed (wheel speed) of a drive wheel of the vehicle 1; an acceleration sensor that detects the acceleration acting on a vehicle 1; a gyro sensor that detects the posture or the direction of progress of the vehicle 1; and a yaw rate sensor that detects the yaw rate (rotational angular speed around a vertical axis of the center of gravity of the vehicle) of the vehicle 1.

The vehicle state sensor 12 further includes a receiver that receives a positioning signal from a positioning system (for example, global positioning system: GPS, global navigation satellite system: GNSS or the like) used to measure the position of a host vehicle by means of artificial satellites. The vehicle state sensor 12 detects the current position of the vehicle 1 based on the positioning signal. Furthermore, by using a result of an arithmetic processing of an autonomous navigation using the yaw rate and the speed of the vehicle 1 which is calculated based on the wheel speed, it is possible to detect the current position of the vehicle 1 with higher accuracy.

In addition, the vehicle state sensor 12 further includes a sensor that outputs a signal indicating a shift position of a shift lever 1b (refer to FIG. 2) to the controller 14, and a sensor that outputs a signal indicating an operating state of a parking brake to the controller 14.

The input device 13 outputs various signals corresponding to input operations of an operator (for example, the driver) to the controller 14.

The controller 14 recognizes a drunk state of the driver, states of the vehicle 1, and driving operations of the driver based on various signals input from the alcohol detector 11 (alcohol sensor 11A), the vehicle state sensor 12, and the input device 13, and controls the whole operation of the vehicle 1 based on those recognition results.

Specifically, the controller 14 includes a vehicle control unit 21 and a drive control unit 22. The vehicle control unit 21 recognizes the drunk state of the driver, the states of the vehicle 1, and the driving operations of the driver based on the various input signals, and controls the drive control unit 22 based on those recognition results so that the vehicle 1 runs appropriately. In addition, the vehicle control unit 21 controls the reporting device 18 so as to report necessary information to the driver.

The drive unit 22 performs the running control (for example, the speed control, the braking control, the steering angle control, and the like) of the vehicle 1 by controlling the throttle actuator 15, the brake actuator 16, and the steering actuator 17 according to the control of the vehicle control unit 21.

The vehicle control unit 21 determines whether the driver is a drunk person based on the signal which is input from the alcohol sensor 11A and indicates the detection result of the alcohol density. For example, when the alcohol density is greater than or equal to a predetermined value, the vehicle control unit 21 determines that the driver is a drunk person.

In a case where the vehicle control unit 21 determines that the driver is a drunk person, if the vehicle 1 is running, the vehicle control unit 21 controls the reporting device 18 so as to output an alarm, and controls the drive control unit 22 so that the vehicle 1 automatically slows down and stops.

In addition, the vehicle control unit 21 stops a driving source (for example, internal combustion engine or the like) of the vehicle 1 when the state of the vehicle 1 satisfies a predetermined condition.

In contrast, in a case where the vehicle control unit 21 determines that the driver is not a drunk person during a run of the vehicle 1, the vehicle control unit 21 allows the vehicle 1 to be driven continuously.

The vehicle control unit 21 controls the alcohol sensor 11A so that an alcohol detection (that is, a detection of the alcohol density) is started during the run of the vehicle 1 just after the vehicle 1 starts up and initially moves. When the vehicle control unit 21 determines that the driver is a drunk person based on a detection result of the alcohol density, the vehicle control unit 21 controls the drive control unit 22 so that the vehicle 1 automatically slows down and stops.

In addition, in a case where the vehicle control unit 21 determines that the driver is not a drunk person, the vehicle control unit 21 controls the alcohol sensor 11A so that a new alcohol detection is not started until at least one of a first condition in which a shift position operated by the shift lever lb or the like is shifted to a position (for example, parking position, neutral position, or the like) other than a drive position and a second condition in which an operation of a parking brake is performed by an operation of a parking brake lever 1c (refer to FIG. 2) or the like is established.

In contrast, when at least one of the first condition and the second condition is established, the vehicle control unit 21 controls the alcohol sensor 11A so that the new alcohol detection is started, and determines whether the driver is a drunk person based on a new detection result obtained from the alcohol sensor 11A.

In addition, the vehicle control unit 21 controls the drive control unit 22 to regulate the speed of the vehicle 1 to a predetermined speed or less (for example, 15 km/h or the like) until a determination result indicating whether the driver is a drunk person is obtained.

In a case where the vehicle control unit 21 determines that the driver is a drunk person, even if an acceleration pedal of the vehicle 1 is stepped, the drive control unit 22 forcibly slows down and stops the vehicle 1 by controlling the throttle actuator 15 and the brake actuator 16.

For example, the reporting device 18 includes a tactual transmission device, a visual transmission device, and an aural transmission device.

For example, the tactual transmission device is a seat belt device, a steering control device, or the like, and based on a control signal input from the vehicle control unit 21, the tactual transmission device generates a predetermined tensile force to exert a tightening force on a seat belt which the driver of the vehicle 1 can tactually perceive, or generates vibration (steering wheel vibration) of the steering wheel 32 which the driver can tactually perceive.

For example, the visual transmission device is a display device or the like, and based on a control signal input from the vehicle control unit 21, the visual transmission device displays predetermined alarm information on the display device, or blinks a predetermined alarm lamp.

For example, the aural transmission device is a speaker or the like, and based on a control signal input from the vehicle control unit 21, the aural transmission device outputs a predetermined alarm sound, a voice, or the like.

The vehicle control system 10 according to the embodiment has the configuration. Subsequently, an operation of the vehicle control system 10 will be described.

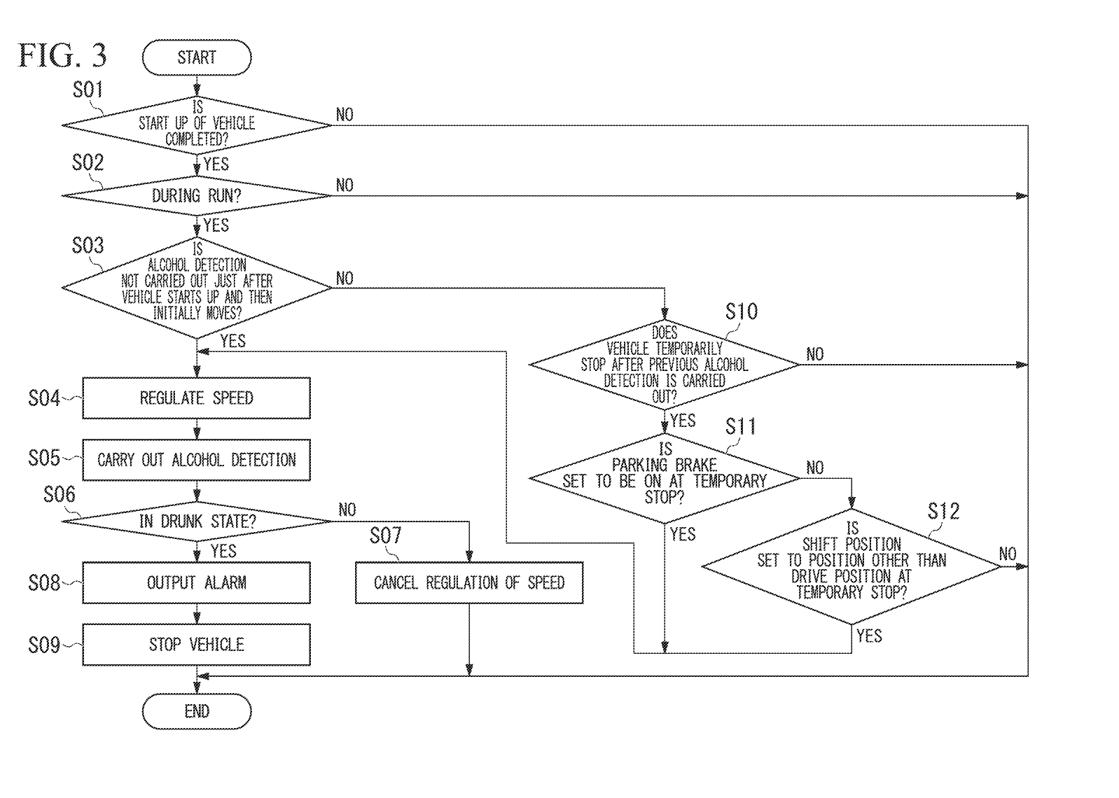

FIG. 3 is a flow chart showing a drunk driving prevention process carried out by the controller 14 (mainly vehicle control unit 21).

For example, the drunk driving prevention process illustrated in FIG. 3 is repeatedly carried out at a predetermined interval.

As shown in FIG. 3, first, in step S01 of the drunk driving prevention process, the vehicle control unit 21 determines whether a start up of the vehicle 1 is completed based on the vehicle information such as the engine speed, the water temperature, or the oil temperature of the vehicle 1.

In step S01, when the vehicle control unit 21 determines that the start up of the vehicle 1 is not completed, that is, when the determination result of step S01 is “NO”, the vehicle control unit 21 ends the current drunk driving prevention process.

In contrast, in step S01, when the vehicle control unit 21 determines that the start up of the vehicle 1 is completed, that is, when the determination result of step S01 is “YES”, the vehicle control unit 21 proceeds to next step S02.

In step S02, the vehicle control unit 21 determines whether the vehicle 1 is running based on the vehicle information such as the speed of the vehicle 1.

In step S02, when the vehicle control unit 21 determines that the vehicle 1 is not running, that is, when the determination result of step S02 is “NO”, the vehicle control unit 21 ends the current drunk driving prevention process.

In contrast, in step S02, when the vehicle control unit 21 determines that the vehicle 1 is running, that is, when the determination result of step S02 is “YES”, the vehicle control unit 21 proceeds to next step S03.

In step S03, the vehicle control unit 21 determines whether an alcohol detection is not carried out just after the vehicle 1 starts up and initially moves (that is, an initial movement among movements and drive stops which can be repeatedly carried out after the vehicle 1 starts up).

In step S03, when the vehicle control unit 21 determines that the alcohol detection is carried out, that is, when the determination result of step S03 is “No”, the vehicle control unit 21 proceeds to step S10 to be described later.

In contrast, in step S03, when the vehicle control unit 21 determines that the alcohol detection is not carried out, that is, when the determination result of step S03 is “YES”, the vehicle control unit 21 proceeds to next step S04.

In step S04, the vehicle control unit 21 controls the drive control unit 22 to regulate the speed of the vehicle 1 to a predetermined speed or less (for example, 15 km/h or the like).

In next step S05, the vehicle control unit 21 controls the alcohol sensor 11A so that the alcohol detection is started. In this step S05, the vehicle control unit 21 may control the reporting device 18 so as to output a message or a voice which requests the driver to exhale.

In next step S06, the vehicle control unit 21 determines whether the driver is a drunk person based on a detection result of the alcohol density obtained from the alcohol sensor 11A.

In step S06, when the vehicle control unit 21 determines that the driver is not a drunk person, that is, when the determination result of step S06 is “NO”, the vehicle control unit 21 proceeds to step S07.

In step S07, the vehicle control unit 21 controls the drive control unit 22 so as to cancel the speed regulation of the vehicle 1, and then ends the current drunk driving prevention process.

In contrast, in step S06 described above, when the vehicle control unit 21 determines that the driver is a drunk person, that is, when the determination result of step S06 is “YES”, the vehicle control unit 21 proceeds to step S08.

In step S08, the vehicle control unit 21 controls the reporting device 18 so as to output an alarm which warns that the driver is drunk.

In next step S09, the vehicle control unit 21 controls the drive control unit 22 so that the vehicle 1 automatically slows down and stops. Then, the vehicle control unit 21 ends the current drunk driving prevention process after the vehicle control unit 21 stops the driving source (for example, engine or the like) of the vehicle 1 if necessary.

In step S10, the vehicle control unit 21 determines whether the vehicle 1 temporarily stops after the previous alcohol detection is carried out.

In step S10, when the vehicle control unit 21 determines that the vehicle 1 does not temporarily stop after the previous alcohol detection is carried out, that is, when the determination result of step S10 is “NO”, the vehicle control unit 21 allows the vehicle 1 to be driven continuously, and then ends the current drunk driving prevention process.

In contrast, in step S10, when the vehicle control unit 21 determines that the vehicle 1 temporarily stops after the previous alcohol detection is carried out, that is, when the determination result of step S10 is “YES”, the vehicle control unit 21 proceeds to next step S11.

In step S11, the vehicle control unit 21 determines whether the parking brake is operated to “ON” at the time of a temporary stop of the vehicle 1.

In step S11, when the vehicle control unit 21 determines that the parking brake is operated to “ON” at the time of the temporary stop of the vehicle 1, that is, when the determination result of step S11 is “YES”, the vehicle control unit 21 proceeds to step S04 described above. In this way, when the determination result of step S11 is “YES”, that is, when a state where the driver can be switched to a different person at the time of the temporary stop of the vehicle 1 occurs, the speed regulation of the vehicle 1 and the alcohol detection are carried out again.

In contrast, in step S11, when the vehicle control unit 21 determines that the parking brake is not operated to “ON” at the time of the temporary stop of the vehicle 1, that is, when the determination result of step S11 is “NO”, the vehicle control unit 21 proceeds to step S12.

In step S12, the vehicle control unit 21 determines whether the shift position of the shift lever 1b is shifted to a position other than the drive position at the time of the temporary stop of the vehicle 1.

In step S12, when the vehicle control unit 21 determines that the shift position is shifted to a position other than the drive position, that is, when the determination result of step S12 is “YES”, the vehicle control unit 21 proceeds to step S04 described above. In this way, when the determination result of step S12 is “YES”, that is, when a state where the driver can be switched to a different person at the time of the temporary stop of the vehicle 1 occurs, the speed regulation of the vehicle 1 and the alcohol detection are carried out again.

In contrast, in step S12, when the vehicle control unit 21 determines the shift position is not shifted to a position other than the drive position, that is, when the determination result of step S12 is “NO”, the vehicle control unit 21 allows the vehicle 1 to be driven continuously, and then ends the current drunk driving prevention process.

As described above, according to the vehicle control system 10 of the embodiment, since the alcohol detection is carried out during the run just after the vehicle 1 moves, it is possible to accurately prevent a drunk person from pretending a non-drunk person and driving the vehicle 1.

In addition, until a state (for example, a state that the shift position is shifted to a position other than the drive position, or a state that the parking brake is operated) that the switching of the driver can be carried out occurs, that is, until a state that a drunk person can pretend a non-drunk person occurs, a new alcohol detection is not carried out.

Therefore, it is possible to accurately prevent a drunk person from pretending to be a non-drunk person and driving the vehicle 1, and since the frequency of the alcohol detection can be minimized, it is possible to reduce botheration of the alcohol detection when a non-drunk person drives the vehicle 1.

Furthermore, since the speed of the vehicle 1 is regulated to a predetermined speed or less until a determination result indicating whether the driver is a drunk person is obtained, it is possible to ensure a desired level of safe driving even if the driver is a drunk person.

### MODIFICATION EXAMPLE

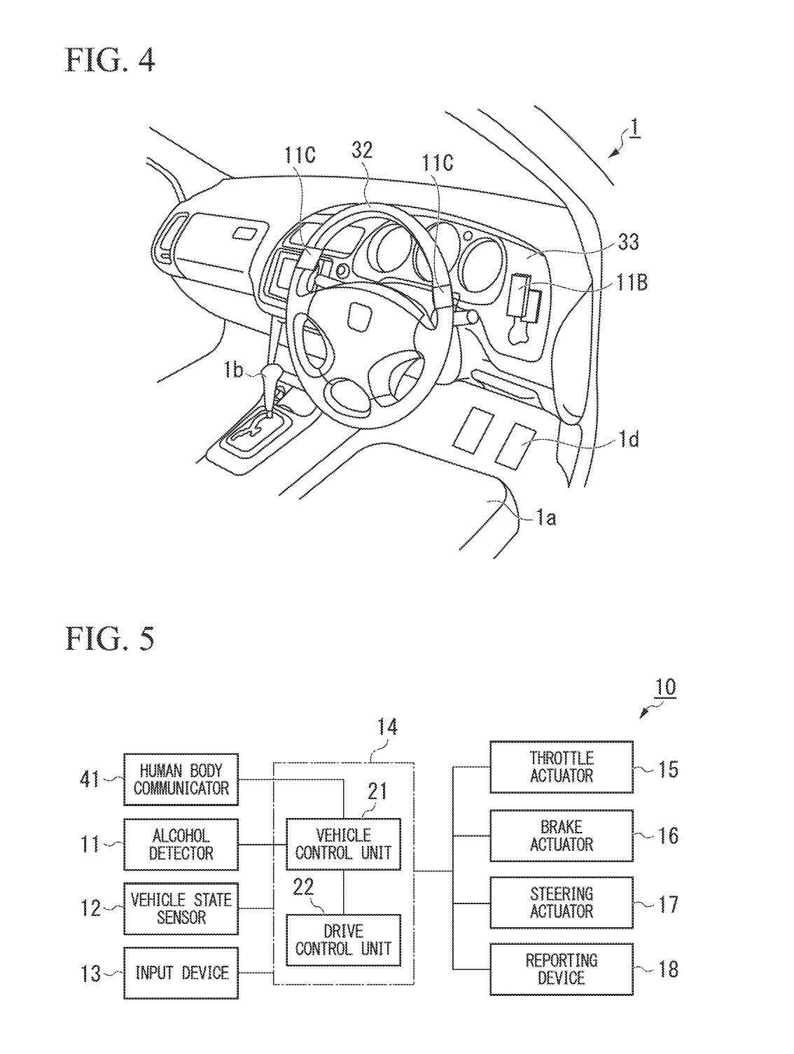

FIG. 4 and FIG. 5 show a vehicle control system 10 according to a modification example of the embodiment. The vehicle control system 10 according to the modification example further includes a human body communicator 41 which carries out a human body communication using the driver as a communication medium. For example, the human body communicator 41 carries out a human body communication between the steering wheel 32, and the driver seat 1a or an acceleration pedal 1d.

In the modification example, based on a state of the human body communication carried out by the human body communicator 41, the vehicle control unit 21 determines whether a person holding the steering wheel 32 is the same as a person who sits in the driver seat 1a or operates the acceleration pedal 1d.

In the modification example, for example, the alcohol detector 11 includes a breathalyzer type alcohol sensor 11B disposed on the instrument panel 33 farther outside than the steering wheel 32 in the width direction of the vehicle 1, and two touch type alcohol sensors 11C provided on the steering wheel 32. The breathalyzer type alcohol sensor 11B detects the alcohol density in the exhalation of the driver as the alcohol intake level. The touch type alcohol sensors 11C detect the alcohol density in the sweat secreted from surfaces of the palm or the fingers of the driver, or in the subcutaneous tissues of the driver as the alcohol intake level.

According to the modification example, it is possible to further accurately prevent a drunk person from pretending a non-drunk person and driving the vehicle 1.

In the embodiment, in addition to the alcohol detection carried out by the alcohol detector 11 after the vehicle 1 starts up, an alcohol detection may be carried out by the alcohol detector 11 even before the vehicle 1 starts up.

In addition, in the embodiment, the breathalyzer type alcohol sensor 11A (or 11B) and the touch type alcohol sensors 11C are exemplified. However, it is possible to use any kind of alcohol sensors capable of detecting the alcohol intake level of the driver.

The embodiment is proposed as an example, and is not intended to limit the scope of the present invention. Various new embodiments other than the embodiment can be put into practice, and various omissions, replacements, and modifications can be made to the embodiment as long as there is no departure from the idea of the present invention. The embodiment or the modification thereof is included in the scope or the idea of the present invention, and is included in the scopes of the claims of the present invention and the equivalents thereof.

What is claimed is:

1. A vehicle control system comprising:
an alcohol detector which detects an alcohol intake level of a driver of a vehicle; and
a controller which controls the alcohol detector so that a detection of the alcohol intake level is started during a run of the vehicle just after the vehicle starts up and initially moves,
wherein the controller determines whether the driver is a drunk person based on a detection result obtained from the alcohol detector, and
wherein the controller stops the vehicle when the controller determines that the driver is the drunk person.

2. The vehicle control system according to claim 1,
wherein in a case where the controller determines that the driver is not the drunk person, the controller controls the alcohol detector so that a new detection of the alcohol intake level is not started until at least one of a first condition in which a shift position of the vehicle is shifted to a position other than a drive position and a second condition in which an operation of a parking brake of the vehicle is performed, is established, and
wherein when at least one of the first condition and the second condition is established, the controller controls the alcohol detector so that the new detection of the alcohol intake level is started, and determines whether the driver is the drunk person based on a new detection result obtained from the alcohol detector.

3. The vehicle control system according to claim 1,
wherein the controller regulates a speed of the vehicle to a predetermined speed or less until a determination result indicating whether the driver is a drunk person is obtained.

4. The vehicle control system according to claim 1,
wherein the alcohol detector includes a breathalyzer type alcohol sensor provided farther outside than a steering wheel of the vehicle in a width direction of the vehicle.

5. The vehicle control system according to claim 1, further comprising
a human body communicator which carries out a human body communication using the driver as a communication medium,
wherein the alcohol detector includes a touch type alcohol sensor provided on a steering wheel of the vehicle,
wherein the human body communicator carries out the human body communication between the steering wheel, and a driver seat or an acceleration pedal of the vehicle, and
wherein the controller determines whether a person holding the steering wheel is the same as a person who sits in the driver seat or operates the acceleration pedal, based on a state of the human body communication carried out by the human body communicator.
